(19) United States
(12) Patent Application Publication
(10) Pub. No.: US 2005/0197247 A1
(43) Pub. Date: Sep. 8, 2005

(54) High utilization supported catalyst compositions with improved resistance to poisoning and corrosion

(76) Inventors: David S. Wainwright, Vancouver (CA); Silvia Wessel, Coquitlam (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/004,034

(22) Filed: Dec. 3, 2004

Related U.S. Application Data
(63) Continuation of application No. 10/114,663, filed on Apr. 2, 2002, now abandoned.
(60) Provisional application No. 60/282,246, filed on Apr. 6, 2001.

(51) Int. Cl. B01J 21/18; H01M 4/96; H01M 4/88

(52) U.S. Cl. 502/180; 502/185; 429/40; 429/44; 502/101

(57) ABSTRACT

A supported catalyst composition comprising a metal catalyst nanodispersed in a support that is a hard disordered carbon or carbon glass; or a partially graphitized or disordered carbon intercalation complex; or “house-of-cards” transition metal dichalcogenide such as molybdenum disulfide (MoS₂). Also disclosed are embodiments based on the above supported catalyst compositions, wherein the metal catalyst is Pt or Pt alloy, and wherein the “pores” comprised in the support are engineered to provide selective access to H₂, but not to larger molecules, such as CO or H₂O. Disclosed are methods for improving catalyst utilization, resistance to poisoning, and resistance of catalyst supports to corrosion—as well as products related thereto. Also disclosed is an MEA that comprises the supported, nanodispersed Pt and Pt alloy catalyst compositions of this invention, and a fuel cell that contains such an MEA.

### CROSS-REFERENCE TO RELATED APPLICATION

This application is a continuation of U.S. patent application Ser. No. 10/114,663, filed Apr. 2, 2002, now pending, which application is incorporated herein by reference in its entirety.

### BACKGROUND OF THE INVENTION

1. Field of the Invention

This invention relates generally to supported, nanodispersed catalyst compositions, particularly platinum catalyst compositions for electrochemical fuel cells.

2. Description of the Related Art

The utilization of noble metal catalysts, such as platinum (Pt) and Pt alloys, has become more economically feasible, thanks largely to advancements in technology allowing such catalyst material to be divided on a much finer scale, thereby, dramatically increasing the surface area available to reactants from a given weight of catalyst. One notable example is the emergence of electrochemical fuel cell technology as an economically viable alternative to conventional vehicular power plants and stationary power plants for the generation of electrical power. More specifically, in 1980, the cost of the platinum catalyst required for a seven-kilowatt fuel cell was $7,000. Today, that cost has been reduced to $50.00.

In general terms, a fuel cell converts a fuel, such as hydrogen or methanol, and oxygen into electricity and water. Its key components are an anode, electrolyte, and cathode. Fuel cells are often classified according to the type of electrolyte that they use. Accordingly, there are alkaline, acid, molten carbonate, solid oxide, and polymer electrolyte membrane (PEM) fuel cells. Fuel cells that use a PEM as the electrolyte are often favored as they are less expensive to manufacture than other types of fuel cells, are more efficient and practical for transportation and smaller-scale applications, operate at relatively low temperatures (typically about 80° C.), achieve high power densities, and can respond rapidly to changes in load.

The PEM, a thin polymeric film, is “sandwiched” between, and in intimate contact with, the anode and cathode. Each electrode comprises an electrically conductive substrate, coated on one side with a thin layer of catalyst—typically platinum or a platinum alloy—that contacts the PEM. The catalyst is needed to induce the desired electrochemical reactions at the electrodes. The catalyst may be an unsupported, finely divided metal (metal black), or may be a supported metal. Typically, the catalyst layer comprises supported, finely divided Pt or Pt alloy, wherein the latter is deposited on carbon particles as the catalyst support. The anode/PEM/cathode combination is referred to as the membrane electrode assembly (MEA). The MEA is sandwiched between electrically conductive separator plates (also referred to as fluid flow field plates or current collectors), that may contain passageways for fuel streams, product streams, and coolant. A plurality of fuel cells are typically stacked in series to form a fuel cell stack.

At the anode/PEM interface, the fuel—typically pure H₂ gas, H₂-rich reformate, or an aqueous solution of methanol—reacts to yield protons, electrons, and, when methanol is present, CO₂. The PEM, when hydrated, conducts protons from the anode to the cathode. It does not conduct electrons, which are thereby forced to bypass the electrolyte through an external circuit to reach the cathode, thus generating electrical current. Along the way, electrons are conducted through the electrode substrates and separator plates. Electrons, protons and oxygen combine at the cathode to form water in an exothermic reaction. Catalyst sites, to be effective, should be readily accessible to reactants, electrically connected to the separator plates by way of the electrode substrates, and ionically connected to the PEM so as to make available or receive protons. The sites should also allow other reaction products to readily escape to exhaust routes.

Direct utilization of hydrogen has been questioned by some because of difficulties associated with its handling and distribution. However, most fuel cells are designed to oxidize hydrogen at the anode. Therefore, fuel cell power plants often incorporate a fuel processor to produce hydrogen from hydrocarbon fuel, typically by steam reforming. The hydrogen-rich reformate stream fed to the fuel cell typically comprises small quantities of CO.

Despite improvements in catalysts and catalyst systems, such as those used for fuel cells and other applications, there remains a need for further improvements. More effective utilization of catalysts, such as Pt and Pt alloy catalyst for fuel cells, may still yield significant cost benefits. In the case of fuel cells, it is still possible to use less material for a given application (i.e., electrical power requirement) and reduce catalyst material costs accordingly. However, greater associated cost savings may lie elsewhere. Improved catalyst utilization also translates to improved fuel cell performance (measured as the voltage output for a given current density). The result is a more efficient, smaller, lighter, and less expensive fuel cell power plant—and a very significant potential impact on the viability of fuel cells as a commercial technology. A similar analysis holds true for other applications. It should be noted that catalyst utilization is not only a function of available surface area, but also a function of mass transport to and from the surface area.

Additionally, it is important to avoid poisoning catalysts, such as the Pt catalysts found in fuel cells, catalytic converters, and other applications. For example, Pt catalyst poisoning by CO needs to be dealt with for PEM fuel cells (typically operate at relatively low temperatures) where CO is present in a reformate fuel stream or in an oxidant stream (typically air) contaminated with CO. Even trace amounts of CO in a fuel or oxidant stream can poison the Pt catalyst. A number of methods have been proposed to solve this problem, but tend to add significant complexity and expense to the fuel cell or other application.

Finally, the carbon catalyst support, typically used in fuel cells and other applications, may give way to corrosion (i.e., oxidation) in the presence of water, either during unusual operating conditions, or simply over an extended period of time, leading to loss of supported catalyst. Also, in the case of fuel cells, where large quantities of water may be present at either the anode or cathode, flooding of catalyst layers may ensue. Methods have been proposed that delay or reduce corrosion, but fall short of solving the problem.

Accordingly, there remains a need in the art for improving the utilization of catalysts, such as the Pt and Pt alloy catalysts comprised in PEM fuel cells, for the provision of such supported catalyst compositions that are less susceptible to poisoning by CO and other species, and for the provision of catalyst support materials that are less susceptible to corrosion. This invention fulfills these needs, and provides further related advantages.

### BRIEF SUMMARY OF THE INVENTION

In brief, this invention is directed, in one embodiment, to a supported catalyst composition comprising a metal catalyst nanodispersed in a support that is a hard disordered carbon or carbon glass. The metal may be Pt or Pt alloy. In another embodiment, the support is a partially graphitized or disordered carbon intercalation complex, formed by intercalating, or inserting, species such as the various species that can be intercalated or inserted into graphite to form graphite intercalation complexes (GICs). In yet another embodiment, the support comprises “house-of-cards” transition metal dichalcogenides such as molybdenum disulfide (MoS₂).

The “pores” comprised in the above supports are preferably engineered to provide selective access to H₂, but not to larger molecules, such as CO or H₂O. For all embodiments directed to catalysts used for fuel cells, the support material is electrically conductive and resistant to the acidic conditions encountered in fuel cells.

In yet further embodiments, an MEA is disclosed that comprises the supported, nanodispersed Pt and Pt alloy catalysts of this invention, as is a fuel cell that contains such an MEA.

These and other aspects of this invention will be evident upon reference to the following detailed description. To this end, a number of patent documents are cited hereinto to aid in understanding certain aspects of this invention. Such documents are hereby incorporated by reference in their entirety.

### DETAILED DESCRIPTION OF THE INVENTION

This invention is generally directed to improved catalyst compositions that comprise metal catalysts nanodispersed in supports that provide for improved utilization of the catalysts, where the latter are also less susceptible to poisoning by CO and other chemical species, and where the support is less susceptible to corrosion in the presence of water.

In one embodiment, the catalyst composition comprises a metal catalyst nanodispersed in a support that is a hard disordered carbon or carbon glass. In a more specific embodiment, the metal is Pt or Pt alloy. The Pt or Pt alloy atoms or clusters are nanodispersed in such a support in much the same manner as has been done for Si and other alloying elements in the rechargeable lithium battery industry. As an example, a Pt salt is dispersed or dissolved in a suitable carbonaceous precursor solvent (organic liquid plus epoxy, phenolic, or carbohydrate precursor to yield a disordered carbon or C—O containing polymer to yield a glass) and pyrolyzed to yield a hard partially graphitized carbon, containing Pt clusters dispersed therein. Such supports have much lower densities than graphite and greater “gaps” between graphene sheets. Thus, there is more space between sheets for the insertion of species, such as H₂. Such compositions result in greater effective Pt utilization, owing to this enhanced accessibility of reactants, such as H₂, and to the Pt surface being “exposed” on a nanoscale, that is, as individual atoms or clusters nanodispersed in the partially graphitic carbon support.

In another embodiment, directed to improving the effective utilization of the catalyst by improving the conductivity of reaction products (i.e., protons) away from the catalyst, the support is a partially graphitized or disordered carbon intercalation complex The latter is formed by intercalating, or inserting (by conventional insertion means), species into the partially graphitized carbon support of this invention. The species used may be any of the various species that can be intercalated or inserted into graphite to form graphite intercalation complexes (GICs). The resulting support has an improved proton conductivity, the extent of improvement being a function of the particular species and the amount of species intercalated.

In yet another embodiment, the support comprises “house-of-cards” molybdenum disulfide (MoS₂), a structure related to the above disordered carbon structure, and within which the catalyst is nanodispersed (see U.S. Pat. No. 5,279,805). In this and in other embodiments, if desired, improved electrical contact may be made to the catalyst composition via the use of small particulates mixed with another suitable conductive particulate (e.g., carbon).

Other embodiments are directed to supported catalyst compositions that are resistant to poisoning and corrosion (i.e., oxidation). These embodiments are based on a method similar to that used for adjusting, for selective access of species, “pores” in high lithium capacity hard disordered carbons (i.e., preventing access of liquid electrolyte to “pores” by judicious control of pyrolysis temperature, time, and atmosphere for a given precursor). Using such a method, compositions of this invention are engineered to provide selective access to H₂, but not larger molecules like CO or H₂0. For instance, in the case of a catalyst composition prepared via the pyrolysis of a carbonaceous precursor solvent that contains a Pt salt dispersed therein, hydrogen and other gaseous by-products are generated over a certain temperature range during pyrolysis. The types and amounts of these gaseous by-products can readily be determined as a function of pyrolysis temperature using a residual gas analyzer (RGA) or the like. If pyrolysis is stopped soon after and/or just above the temperatures at which hydrogen is generated, it is expected that hydrogen would still be able to access pores in the pyrolyzed composition (since if hydrogen by-product can still get out, then it is expected that hydrogen can get in). However, when subjected to controlled higher pyrolysis temperatures and/or times, the “house-of-cards” carbonaceous host will become more ordered resulting in a controlled “shrinking” of the “pores”. One result of such “pore” engineering is less susceptibility of the nanodispersed catalyst to poisoning by CO or larger chemical species. The latter simply cannot reach the catalyst residing within the “pores” of the support. Another result is less susceptibility of the support to corrosion. For example, during cell reversal resulting from fuel starvation in an electrochemical fuel cell, a conventional carbon catalyst support at the anode is oxidized by reaction with water and converted to CO₂. This leads to loss of the supported catalyst. Also, conventional carbon catalyst supports at the cathode of a fuel cell can slowly oxidize over time. This leads again to loss of supported catalyst and associated kinetic losses. In addition, the cathode is made more hydrophilic, which leads to flooding and associated mass transport losses. Such losses are largely avoided in embodiments of this invention, where the carbon adjacent to the supported Pt or Pt alloy catalyst is not subject to corrosion during cell reversal, or otherwise, since the water required for the corrosion reaction is not able to access the “pore” wherein resides the catalyst.

Additional embodiments disclose an MEA that comprises the supported, nanodispersed Pt and Pt alloy catalyst compositions of this invention, and a fuel cell that contains such an MEA. For all such embodiments, the support material of the catalyst composition is electrically conductive and resistant to the acidic conditions encountered in fuel cells.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A supported catalyst composition comprising a catalyst nanodispersed within the structure of a support.

2. The supported catalyst composition of claim 1 wherein the support is selected from the group consisting of hard disordered carbons, carbon glasses, partially graphitized carbon intercalation complexes, disordered carbon intercalation complexes, and transition metal dichalcogenides.

3. The supported catalyst composition of claim 1 wherein the support has a “house-of-cards” type of structure.

4. The supported catalyst composition of claim 3 wherein the pores in the support are of a size to provide selective access to hydrogen but to exclude carbon monoxide and water.

5. The supported catalyst composition of claim 1 wherein the catalyst comprises platinum or a platinum alloy.

6. An electrode comprising the supported catalyst composition of claim 1.

7. A membrane electrode assembly comprising the supported catalyst composition of claim 1.

8. A fuel cell comprising the supported catalyst composition of claim 1.

9. A method for making the supported catalyst composition of claim 1 wherein the support is carbon, the method comprising:
mixing a catalyst solution comprising a salt of the catalyst dissolved in a solvent with a carbonaceous precursor solvent comprising a carbonaceous precursor and an organic solvent; and
pyrolyzing the mixture.

10. The method of claim 9 comprising drying the mixture before pyrolyzing.

11. The method of claim 9 comprising intercalating a species into the support thereby forming an intercalation complex support.

12. The method of claim 9 comprising heating the supported catalyst composition in an inert atmosphere at a controlled temperature and for a controlled time such that the size of the pores in the support are adjusted to provide selective access to hydrogen.

13. A method for making the supported catalyst composition of claim 1 wherein the support is a transition metal dichalcogenide, the method comprising:
providing a catalyst solution comprising a salt dissolved in a solvent, the salt comprising the catalyst and other species;
providing a suspension comprising single layers of transition metal dichalcogenide suspended in a suspending liquid;
mixing the catalyst solution with the suspension;
flocculating the mixture, and removing the solvent, the other species, and the suspending liquid.
